(19) United States
(12) Patent Application Publication
(10) Pub. No.: US 2020/0221707 A1
(43) Pub. Date: Jul. 16, 2020

(54) Sanitizing Compositions and Methods for Making and Using Same

(71) Applicant: CLEANSPOT, INC., Albuquerque, NM (US)

(72) Inventors: Thomas S. Corbitt, Albuquerque, NM (US); Charles J. Call, Albuquerque, NM (US); Ana M. Chavez, Albuquerque, NM (US)

(73) Assignee: CLEANSPOT, INC., Albuquerque, NM (US)

(21) Appl. No.: 16/631,144

(22) PCT Filed: Jul. 14, 2018
(86) PCT No.: PCT/US18/42192

§ 371 Date: Jan. 14, 2020

Related U.S. Application Data
(60) Provisional application No. 62/532,364, filed on Jul. 14, 2017.

(51) Int. Cl. A01N 63/14; A01N 31/02; A01N 43/16; A01N 65/34; A01N 47/44; A01N 25/34

(52) U.S. Cl. CPC A01N 63/14; A01N 31/02; A01N 25/34; A01N 65/34; A01N 47/44; A01N 43/16

(57) ABSTRACT

Sanitizing compositions and methods for making and using these compositions are disclosed. In particular, the compositions comprise a fast acting antimicrobial agent and a persistent microbial agent with alcohol and beeswax among the active ingredients. The ethanol content may vary between about 62 vol.-% and 75 vol.-%. The beeswax content may vary between about 0.01 vol.-% and 3 vol.-%. Log reduction in E. coli bacteria>5 was measured at 1 minute, 8 hours and 24 hours.

### RELATED APPLICATIONS

This application is related to and claims the benefit of U.S. Provisional Patent Application 62/532,364, filed Jul. 14, 2017, and entitled “Sanitizing Compositions and Methods for Making and Using Same,” which is hereby incorporated by reference in its entirety.

### FEDERALLY SPONSORED RESEARCH AND DEVELOPMENT

Not applicable.

### FIELD

This disclosure relates to sanitizing compositions and methods for making and using these compositions. In particular, the compositions comprise a fast acting antimicrobial agent and a persistent microbial agent with alcohol and beeswax among the active ingredients.

### BACKGROUND

Sanitizing compositions may be used for sanitizing a variety of surfaces other than human and animal skin. U.S. Patent Application No. 2008/0045491 entitled “SURFACE SANITIZER” discloses compositions formulated as solutions for sanitizing hard surfaces such as countertops and floors, or as solutions/gels for application to animal skin. The non-toxic antimicrobial surface sanitizer composition comprises a water-miscible alcohol (50 wt.-% to 90 wt.-%), water (10 wt.-% to 50 wt.-%), an acid component (0.1 wt.-% to 10 wt.-%) sufficient to maintain the pH of the composition below about 5, and a multivalent cation (e.g., metal ion or metal compound) comprising 0.01 wt.-% to 5 wt.-%. The acid component comprises one or more weak acids having pKa values between about 2 and about 5, and provide persistent antiviral protection after the volatile components have evaporated. The water-miscible alcohol component is at least one of ethanol, n-propanol, isopropanol, n-butanol, 2-butanol, iso butanol and tert-butanol. The water-miscible alcohol component has a dielectric constant that is less than about 23. The acid component is at least one of phosphoric acid, acetic acid, propionic acid, citric acid, glycine, malic acid, glycolic acid, salicylic acid, benzoic acid, ascorbic acid and succinic acid. The composition may also include one or more of an emollient comprising 0.01 wt.-% to 0.5 wt.-%, oxidative agent, humectant comprising 0.01 and 1%, lubricants such as beeswax, jojoba oil, lanolin, almond oil, olive oil, shea butter comprising 0.01 wt.-% to 0.5 wt.-%, plant-derived alkene, and plant-derived essential oil. The multivalent cation component includes polymers having at least two positive charges such as polyamines (e.g., polyvinylamine, polyethylenimine, putrescine, spermidine, spermine), chitosan, polylysine, metal ions and metal compounds. The metal component is at least one of aluminum, bismuth, silver, zinc, boron, selenium and nickel. The metal may be provided in the form of a water-soluble salt, organic compound, inorganic compound, dispersion of finely-divided metal, insoluble salt or compound and are used to increase the viscosity of the solution and/or forming a gel, which is beneficial in the preparation a hand sanitizer comprising low pH solutions. Composition that are acidic (pH<5) may provide for persistent antimicrobial activity but are not desirable for sanitizing skin and for sanitizing most surfaces.

Alcohols are considered to be “fast-acting” sanitizing agents. Hand sanitizers with at least a 62 vol.-% ethanol are effective in killing bacteria, such as the Streptococcus bacteria, and are also effective against fungal infections, and common cold and flu viruses. Ethanol and isopropanol kill these microbes/germs by denaturing the protein content and dissolving or lysing their essential proteins. At alcohol content of 62 wt.-% or more, the germs are destroyed in 10 to 15 seconds. Isopropyl alcohol may destroy >99.99% (4 log reduction) of most bacteria in <30 seconds. It has been reported that alcohol rub sanitizers containing at least 62 wt.-% alcohol kill 99.9% (3 log reduction) of the bacteria in about 30 seconds after application, and >99.99% in about 60 seconds. Upon re-exposure to these germs, another application of alcohol containing sanitizing agents would be required to destroy these germs. In hospitals and clinics, the alcohol content in sanitizing compositions used to treat contaminated surfaces is typically 60-95%. These formulations are effective against viruses as well. Sanitizing compositions with high ethanol content are flammable. In addition, it has been reported that children are tempted to ingest high-ethanol containing compositions. Alcohol-based hand sanitizers may cause alcohol poisoning in small children. Further, sanitizing compositions that contain only alcohols as the active ingredients do not have long-lasting or “persistent” sanitizing properties, due to the volatility of the alcohols.

Sanitizers such as PURELL® typically comprise ethyl alcohol as the active ingredient, and other agents such as isopropyl alcohol, carbomer to form a non-foaming gel, tocopheryl acetate (fat soluble vitamin E) as an antioxidant and moisturizer (humectant) to minimize the drying effects of ethanol, glycerol as a moisturizer, propylene glycol as a moisturizer, and isopropyl myristate to balance the consistency of the gel and emollient.

Some hand sanitizer products may be alcohol free and contain sanitizing agents such as povidone-iodine, benzalkonium chloride, and triclosan to kill microorganisms. Although low amounts (0.1 wt.-% to 0.2 wt.-%) of these agents may have the same antimicrobial effects as compositions that contain at least 62 vol.-% ethanol, formulations with triclosan as the active agent have shown high toxicity against infant dermal fibroblasts. Povidone-iodine solutions have been proven to result in dermatitis in as little as 2% iodine in solution, and have been shown to inhibit human fibroblast growth. In contrast to alcohols, some microorganisms may develop a resistance to these agents. U.S. Pat. No. 7,112,559 entitled “THICKENED QUATERNARY AMMONIUM COMPOUND SANITIZER” discloses hand sanitizing compositions that have less than about 30 wt.-% of the total composition of alcohols. The compositions consist of a quaternary ammonium compound (0.01 wt.-% to 3 wt.-%) that provides antimicrobial activity, a thickener in an amount effective (0.001 wt.-% to 5 wt.-%) to provide a viscosity from about 200 to about 5,000 centipoise, and a solvent such as water, ethanol and isopropanol (25 wt.-% to 99 wt.-%). Additives such as pH adjuster, skin conditioner, drying time enhancer, dye, fragrance and mixtures thereof may also be used. The disclosed quaternary ammonium compounds are monoalkyldimethylbenzyl ammonium salts, dialkyldimethyl ammonium salts, polysubstituted quaternary ammonium salts, bis-quaternary ammonium salts, benzalkonium chloride, benzethonium chloride and mixtures. The quaternary ammonium compound, the thickener, and the solvent are considered to be food additives.

“Persistent” sanitizing activity generally refers to extended antimicrobial activity that inhibits the proliferation of microorganisms after application of the sanitizing composition over some extended period of time. As opposed to “fast-acting” ingredients, the time scale for sanitizing could be in the order of hours. For example, NimbuDerm™ (Quick-Med Technologies Inc.) is reported to be an alcohol-free, copolymer based persistent hand sanitizer that provides for long lasting antimicrobial protection, for up to 8 hours. It reportedly can combine the immediate disinfecting behavior of an alcohol-based product with the long-lasting antimicrobial persistence of an advanced bio-active polymer. It utilizes polymeric quaternary polycationic microbicides and achieves its bacteriocidal activity by destabilization of the cell wall structures and by inducing cellular collapse. Inactive ingredients may comprise a gel thickener, emollient, skin freshener, moisturizer, and fragrance. It can be removed with a soap and water wash. It reportedly can act immediately, reducing microbial content by 99.99%.

Patent Application No. CN1965791A, entitled “ANTI-ACNE MOISTURIZING CREAM AND PREPARATION PROCESS THEREOF” discloses acne lotions comprising 3.0-3.5% beeswax, 4.0-5% tea seed oil, 3.0-3.38% white oil, 1.0-1.5% lanolin, 2.22-2.42% polyoxyethylene (2) stearyl ether, 1.78-2.00% polyoxyethylene (21) stearyl ether, 2.00-3.00% polyethylene glycol (PEG) 400, 5.00-5.86% glycerin, 0.25-0.3% borax, 0.49-1.52% tea tree oil, 1.0-1.2% Tween-80, 0.18-0.20% methyl paraben, the balance being water. PEG 400 and glycerin are used as humectants. It discloses that tea tree oil provides antimicrobial activity against many pathogenic bacteria and fungi with bactericidal effect that is 11-13 times stronger than that of phenol. These compositions are not known to provide fast acting anti-microbial activity.

Many sanitizers on the market contain glycerin, which is added to combat the loss of moisturization that can occur due to the drying effect of alcohol. Glycerin is effective as a moisturizer, but also has the undesired effect of leaving the skin feeling oily or greasy. Sanitizing compositions that provide for fast acting antimicrobial activity, persistent antimicrobial activity that are glycerin-free and do not cause skin to become excessively dry are needed.

### SUMMARY

This disclosure relates to sanitizing compositions and methods for making and using these compositions. In particular, the compositions comprise a fast acting antimicrobial agent and a persistent microbial agent with alcohol and beeswax among the active ingredients.

In one exemplary aspect, the sanitizing composition may comprise (a) a hydrophobic material comprising at least one of beeswax, bee propolis, and soy wax, and oil extracted from beeswax, and mixtures thereof and (b) a solvent comprising at least one of water, isopropyl alcohol, ethanol, and mixtures, wherein the hydrophobic material provides all, or in part, the function of a persistent antimicrobial agent and the solvent provides all, or in part, the function of a fast acting antimicrobial agent. The beeswax content in the exemplary sanitizing composition may vary between 0.1 vol.-% and 3 vol.-%, preferably between 0.5 vol.-% and 2 vol.-%, and most preferably between 0.1 vol.-% and 0.4 vol.-%. The ethanol content may be between 60 vol.-% and 75 vol.-%, and preferably between 62 vol.-% and 70 vol.-%, and the isopropyl alcohol content may be between 3 vol.-% to 5 vol.-%.

In another aspect, the sanitizing composition may further comprise at least one of epsilon polylysine (EPL), tea tree oil, eugenol, oil extracted from beeswax, poly hexamethylene biguanide (PHMB), and polyaminopropyl biguanide (PAPB), and mixtures thereof. The sanitizing composition may further comprise at least one of vitamin E extract (tocopherol preferably in acetate form), apricot seed oil, and essential oils. The vitamin E content may be less than about 0.3 vol.-% and the apricot seed oil content may be less than about 1 vol.-%. The essential oil content may be less than about 0.3 vol.-%. The EPL content may be less than about 0.2 vol.-%, and preferably less than about 0.07 vol.-%.

Another exemplary sanitizing composition may comprise (all percentages in vol.-%): 62% to 70% ethanol, 3% to 5% isopropyl alcohol, 0.1% to 0.4% beeswax, less than 0.1% epsilon polylysine (EPL), less than 0.9% apricot seed oil, less than 0.3% tocopherol (Vitamin E), and less than 0.3% essential oil extracts, with the remainder being water. The sanitizing composition may further comprise at least one of a bittering agent and a thickening agent. The thickening agent may comprise at least one of calcium acetate, bentonite, aluminosilicate, Carbopol, guar gum, cellulose, and corn starch. The pH of the sanitizing composition may be between 5 and 9. The kinematic viscosity (at about 25° C.) of the sanitizing composition may be less than about 10 cSt.

Another exemplary bee byproduct sanitizing composition may comprise at least one of beeswax, bee propolis, and oil extracted from beeswax, and mixtures thereof, wherein the bee byproduct content is between about 0.01 vol.-% and 3 vol.-%.

Another exemplary bee byproduct sanitizing composition may comprise at least one of beeswax, bee propolis, and oil extracted from beeswax, and mixtures thereof, wherein the bee byproduct content is between about 0.2 vol.-% and 1 vol.-%.

Another exemplary bee byproduct sanitizing composition may comprise at least one of beeswax, bee propolis, and oil extracted from beeswax, and mixtures thereof, wherein the bee byproduct content is between about 0.02 vol.-% and 0.05 vol.-%. The kinematic viscosity (at about 25° C.) of the above sanitizing compositions may be less than about 10 cSt.

The sanitizing compositions may be used for hand sanitizing purposes wherein they are dispensed from suitable hand sanitizing dispensers. The disclosed compositions may also be used in the form of sanitizing (or disinfecting) wipes. An exemplary wipe may comprise a wipe substrate comprising at least one of exemplary sanitizing composition disclosed herein.

An exemplary method for preparing at least one of the disclosed sanitizing compositions comprises forming an emulsion of beeswax and EPL, adding the emulsion to an aliquot of the total amount of ethanol (e.g. SDA-3C alcohol) required for the composition while stirring/mixing to form a first mixture, adding the first mixture to the remaining amount of ethanol while mixing to form a second mixture, adding predetermined amounts of water and at least one of isopropyl alcohol, apricot seed oil, Vitamin E extract (preferably in acetate form), and essential oils (fragrance) to the second mixture while mixing to form the sanitizing composition. The aliquot of ethanol may be between about 1 wt.-% and 2 wt.-% of the total amount of ethanol required to prepare a batch of the sanitizing composition. The emulsion of beeswax and EPL may be added to the center of the vortex formed during stirring/mixing of the aliquot of ethanol.

Another exemplary sanitizing composition may comprise (all percentages in vol.-%): 62% to 70% ethanol, 3% to 5% isopropyl alcohol, less than about 0.05% beeswax, less than 0.1% epsilon polylysine (EPL), less than about 0.9% apricot seed oil, less than about 0.3% tocopherol (Vitamin E), and less than about 0.3% essential oil extracts, with the balance being water.

Other features and advantages of the present disclosure will be set forth, in part, in the descriptions which follow and the accompanying drawing, wherein the preferred aspects of the present disclosure are described and shown, and in part, will become apparent to those skilled in the art upon examination of the following detailed description taken in conjunction with the accompanying drawings or may be learned by practice of the present disclosure. The advantages of the present disclosure may be realized and attained by means of the instrumentalities and combinations particularly pointed out in the appendant claims.

### BRIEF DESCRIPTION OF THE DRAWING

The foregoing aspects and many of the attendant advantages of this disclosure will become more readily appreciated as the same becomes better understood by reference to the following detailed description, when taken in conjunction with the accompanying drawing, wherein:

FIG. 1. Representative method for making an exemplary sanitizing composition comprising beeswax.

All reference numerals, designators and callouts in the figure are hereby incorporated by this reference as if fully set forth herein. The failure to number an element in a figure is not intended to waive any rights. Unnumbered references may also be identified by alpha characters in the figures and appendices.

### FURTHER DESCRIPTION

Particular aspects of the invention are described below in considerable detail for the purpose for illustrating the compositions and uses. However, various modifications may be made, and the scope of the invention is not limited to the exemplary aspects described.

Exemplary hand sanitizing compositions may comprise a hydrophobic material comprising at least one of beeswax, oil extracted from beeswax, bee propolis, soy and other vegetable-based waxes, and mixtures thereof, and a solvent comprising at least one of water, isopropyl alcohol, ethanol, and mixtures thereof. Isopropyl alcohol and tertiary butyl alcohol can be used to denature ethanol containing sanitizers to render these sanitizers toxic and to deter ingestion by humans. In the U.S., a denaturant must be added to ethanol-based products so that consumers are not induced to ingest them. There are a number of government-approved denaturants including isopropyl and tertiary butyl alcohol. The hydrophobic material also provides all, or in part, the function of a persistent antimicrobial agent and the solvent provides all, or in part, the function of a fast acting antimicrobial agent.

Ethanol based solvents may function both as a solvent and a fast acting antimicrobial agent. The term “solvent” is also used to include constituents that perform the function of a diluent. mixtures of ethanol and mixtures of ethanol and other alcohols. Alcohols are generally available as alcohol-water mixtures, and the use of the term “alcohol” encompasses both pure alcohol and alcohol/water mixtures. Antimicrobial agents have the capacity to reduce microbial content by 99.9% (3-log reduction) and preferably by 99.99% (4-log reduction). Microbes include bacteria, viruses, and fungi.

An exemplary sanitizing composition comprises isopropyl alcohol with an amount less than about 5 wt.-%. Glycerol (glycerin) is generally not desirable because it gives the skin an oil or greasy feel. Ethanol is a commodity chemical, most often produced by the fermentation of corn in the U.S.

In an exemplary composition, the sanitizer is comprised of at least 95% natural ingredients. The U.S. Food and Drug Administration has not defined the word “natural” as it relates to skin sanitization products. However, the Natural Products Association has defined a natural product as one that contains at least 95% natural ingredients. Natural ingredients are ingredients that are derived from plants, animal or mineral sources (excluding petroleum based ingredients), and that are not processed or minimally processed. For example, processing should be through basic physical methods such as filtration and through biological methods such as fermentation. “Natural” and “natural ingredient” are used synonymously in this disclosure.

While ethanol has been discussed as an exemplary fast-acting antimicrobial agent, other less-volatile ingredients may have a long-acting, or persistent anti-microbial effect. Exemplary persistent antimicrobial agents may comprise beeswax, bee propolis, antimicrobial peptides such as epsilon polylysine (EPL), cationic polymers such as polyhexamethylene biguanide (PHMB), polyaminopropyl biguanide (PAPB) and analogs of these compounds, oil extracts of beeswax and plants, and combinations and mixtures thereof. Other examples of persistent antimicrobial agents include nano-silver particles, silver, silver compounds, copper, copper compounds, zinc compounds, titanium compounds, ammonium alum, and compounds containing quaternary ammonium functional groups.

Beeswax, in addition to providing moisturizing properties, also provides persistent antimicrobial properties. Bees wax is a mixture of esters, fatty acids, higher alcohols and saturated hydrocarbons in addition to aromatic substances and pigments. Beeswax was found to be particularly active against Bacillus alvei, Proteus vulgaris, Salmonella gallinarum and Bacillus subtilis. It may be effective against gram positive and gram negative bacteria and showed pronounced inhibitory effect against Candida albicans, Listeria monocytogenes, Pseudomonas aeruginosa; Staphylococcus aureus, Salmonella enteric, Escherichia coli and microscopic fungi (Aspergillus fumigatus, Aspergillus flavus, Aspergillus niger, and different strains of yeasts Candida krusei, Candida albicans, Candida glabrata, Candida parapsilosis, Candida tropicalis, Geotrichum candidum, and Rhodotorula mucilaginosa [1-2].

Paraffin or vegetable based waxes and other hydrophobic materials with different molecular weights (MW) may be employed in sanitizing compositions for different applications. For example, in the case of PEG, the selection of a specific PEG MW can depend on the intended use of the sanitizing composition. PEG is generally hydrophilic, but when a coating containing PEG is dried, it dissolves very slowly in water. It therefore, behaves as a hydrophobic coating when dried and forms a barrier against water and slowly ablates or dissolves upon repeated contact. Compositions comprising low MW PEG and similar waxes (e.g., <1000 Da molecular weight) are soft when dry, and have hardness similar to furniture wax. They smear readily and are likely to be good for sanitizing touchscreens and in hand sanitizers. The mid-grade MW PEG and similar waxes (e.g., MW of about 8000 Da) may be used in compositions for sanitizing countertops (e.g., the composition is applied as a coating on to the surface) and other frequently touched surfaces where long-lasting coating persistence (or sanitizing durability) is desired than can be achieved with the low MW waxes. The performance of a coating comprising beeswax is similar to the mid-range PEG. Low and mid-grade MW PEG (MW about 8000 Da) and waxes may be used when the coating is expected to be reapplied regularly, such that long-term durability is not needed, for example in hand sanitizers. High MW PEG and similar wax solutions (MW>20,000 Da), when cured, yield coatings that are hard, but not quite as hard as car wax. Coatings comprising high MW waxes may be useful for household cleaners where the surface is not likely to be rubbed frequently, or when long-term durability is desired. These coatings tend to separate from the surface and agglomerate (or ball up) if rubbed vigorously. They might be useful as an anti-mold dip coating or spray coat on surfaces in the bathroom, or on wood.

The antimicrobial properties of beeswax may be enhanced with tea tree extract (oil) or Manuka oil (Living Nature, New Zealand). Manuka oil is extracted from beeswax produced from bees that feed almost exclusively on tea tree flowers. Manuka honey is also known to have antimicrobial properties and is approved by the Food and Drug Association as an antimicrobial agent. In addition to the tea tree extract, many other extracts, also known as “essential oils,” are well-known antimicrobial agents. These agents are generally not “fast acting.” Rather, when applied, and preferably applied often, they provide some degree of persistent antimicrobial effect.

The hydrophobic material provides an effective moisturizing function when the sanitizing composition is applied to human skin, for example, when it dispensed from a hand sanitizer dispenser. As previously described, beeswax is a hydrophobic material that provides for effective moisturizing properties. Bee byproducts need not be limited to beeswax, but may comprise bee propolis, oil extracted from beeswax, and mixtures thereof. Other exemplary hydrophobic materials include one or more of paraffin based waxes, plant-based waxes, bee propolis, and poly ethylene glycol (PEG). Mixtures of wax and oil may also be used to provide moisturizing properties. In general, a wax is a hydrophobic solid at room temperature, and an oil is hydrophobic liquid at room temperature. Many waxes are solid at room temperature, but become oily liquids at higher temperatures. In general, if a material does not flow in a manner visible to the human eye in a matter of seconds when unconstrained on a substantially non-horizontal surface, for example, at a 45-degree incline, a material is considered to be a solid. Alternately, if flow of the material is visible, a material is considered to be a liquid. The term “wax” and mixtures of wax and oil are considered to be “wax” if the mixture is solid at room temperature. Waxes include but are not limited to natural materials such as soy wax, palm wax, apricot seed wax, grape seed wax, avocado wax, and mixtures thereof. Oils include but are not limited to pecan oil and apricot oil and mixtures thereof.

Additives to the hand sanitizing compositions may comprise emollients such as lanolin, vitamin E, vegetable oil, extracts from seeds of fruits and vegetables and an extract of aloe (the term aloe represent the genus, which includes various different species of succulent plants, including but not limited to aloe vera). Emollients may be naturally derived or synthetically derived. Additives may also comprise of an emulsifier. An emulsifier is useful if the any of the other ingredients in the sanitizing composition does not readily dissolve in the solvent and precipitate out of solution or otherwise settle, and helps to keep these ingredients in solution. EPL may act as an emulsifier in addition to a persistent antimicrobial agent. Emulsifiers may also comprise soy or egg lecithin, emulsifying wax, cetearyl alcohol, polysorbate 20, and ceteareth-20. Other classes of polysorbate emulsifiers such as polysorbate 40, polysorbate 60 and polysorbate 80 may also be used. Other ceteareth-n compounds (where n=2 to 100) may also be used. Emulsifying wax is created when a wax material (either a vegetable wax of some kind or a petroleum-based wax) is treated with a detergent (typically sodium dodecyl sulfate or polysorbates) to cause it to make oil and water bind together into a smooth emulsion. It is a white waxy solid with a low fatty alcohol odor. To deter people from consuming ethanol comprising sanitizing compositions, a bittering agent may be included in the composition. An exemplary bitterant is denatonium that is usually available as denatonium benzoate and is an effective bitterant at <10 ppm and often at <1ppm concentrations.

Sanitizing compositions may be in the liquid form that comprises natural ingredients. The hydrophobic agents in these compositions may comprise at least one of beeswax and other natural waxes such as waxes derived from plants and animals (other insect waxes, and lanolin), or mixtures thereof. Plant derived waxes suitable include soy wax, palm wax, avocado wax and wax extracted from seeds of fruits. Bee propolis may also be used a naturally derived hydrophobic material. In an exemplary composition comprising naturally derived materials, both the solvent and the fast acting antimicrobial agent may comprise of ethanol or aqueous ethanol. The persistent antimicrobial agent may comprise naturally derived epsilon polylysine (EPL).

In an exemplary sanitizing composition, the solvent comprises more than 62 vol.-% ethanol, less than 5 vol.-% isopropyl alcohol, and between 0.1 vol.-% and 3 vol.-% beeswax (or beeswax extract). Preferably the beeswax content is between 0.5 vol.-% and 2 vol.-%, and more preferably between 0.1 vol.-% and 0.4 vol.-%.

Another exemplary sanitizing composition may comprise (all percentages in vol.-%): 60% to 75% ethanol, 3% to 5% isopropyl alcohol, 0.1% to 3% beeswax, less than 0.2% epsilon polylysine (EPL), less than 1% apricot seed oil, less than 0.3% tocopherol (Vitamin E), and less than 0.3% essential oil extracts (e.g. extracts of lemon and peppermint) for fragrance. The balance is water. Preferably, the ethanol content is between 62% and 70%. Preferably the EPL content is less than 0.07%. In addition, exemplary compositions may comprise lanolin (less than 0.5%), avocado oil (less than 0.4%) and lecithin (less than 0.3%). Preferably the beeswax content is between 0.5% and 2% and more preferably between 0.1% and 0.4%. As the content of beeswax is increased in the sanitizing composition, a suitable dispersant may be added to maintain the sanitizing composition in a liquid state (in case the sanitizing composition is to be dispensed).

Another exemplary sanitizing composition comprises (a) at least one of beeswax, oil extracted from beeswax, and bee propolis, (b) at least one of benzalkonium chloride and chlorhexidene; and (c) at least one of epsilon polylysine, tea tree oil, eugenol, oil extracted from beeswax, poly hexamethylene biguanide (PHMB), and polyaminopropyl biguanide (PAPB), with the balance being ethanol and water. Chlorhexidine may perform as both a fast acting antimicrobial agent and a persistent antimicrobial agent. In amounts of 1 ppm or more (at least 1 μg/l), it is active against Gram-positive bacteria. Compositions with 10-80 ppm chlorhexidine are effective against Gram-negative bacteria and fungi.

The CDC has expressed concern that non-alcohol based sanitizing compositions, particularly in hand sanitizers, whose active ingredients are limited to quaternary ammonium compounds (notably benzalkonium chloride or benzethonium chloride), tea tree oil and/or thyme, are less effective than alcohol based hand sanitizers. Further, to deter minors from consuming ethanol containing sanitizing compositions, solvents comprising citrus extracts may be used. Citrus extracts have fast acting antimicrobial properties.

Some embodiments may include gritty material in compositions to increase effectiveness of antimicrobial treatment by enhancing mechanical friction. For examples, gritty materials may be used to create mechanical friction to loosen and rinse away microbes (modify the wear properties of the sanitizing composition on a surface such as human skin) and may enhance moisturization properties when the composition is applied to human skin. Examples of gritty materials include but are not limited to kaolin, pumice, sea salt, coconut husk, and apricot shells. Plastic microbeads may be used, but current research suggests that such plastic microbeads are persistent in the environment and are a potential concern. Kaolin, pumice, sea salt, coconut husk, apricot shells, and synthetic aluminosilicate powders may also be used. When the coating is substantially worn in some areas of a frequently touched surface, it may be removed by soap or a solvent such as ethanol (grain alcohol) or rubbing alcohol. The amount of gritty material is preferably less than about 2 wt.-%, and more preferably less than about 1 wt.-%.

Hand sanitizing compositions may be housed in a suitable container and delivered through a special nozzle which mixes the liquid with air to form a thick foam. A foam is beneficial in that it is not as likely to drip off a person's hand while the person is applying the treatment. Sanitizing compositions may comprise a thickening agent to produce a composition that is a gel or viscous liquid. Suitable thickening agents comprise calcium acetate, bentonite, aluminosilicate, and carbopol. Some plant extracts such as guar gum, cellulose, and corn starch may also serve as thickening agents. The hand sanitizing compositions may be provided in bulk form to fill reusable dispensers, in prepacked containers to be used to fill dispensers, in prepacked dispensers of various sizes to be used in restrooms, offices, restaurants and other locations, as well as in small containers for consumers to carry with them for personal use.

The exemplary sanitizing compositions disclosed herein may be used in the form of wipes or may be dispensed as a gel or liquid spray. An exemplary wipe comprises a wipe substrate, a suitable sanitizing composition, and a non-oily moisturizing composition so as not to leave the skin dry or oily. As disclosed herein, the sanitizing compositions may comprise a hydrophobic material, a fast acting antimicrobial agent and a persistent antimicrobial agent. Sanitizing compositions for wipes or sprays or gel dispensers may comprise a thickening agent to produce a composition that is a gel or viscous liquid form. The thickening agent increases the viscosity of the composition to reduce the likelihood that the hand sanitizer will drip-off a person's hands while the person is applying the treatment. Suitable thickening agents comprise calcium acetate, bentonite, aluminosilicate, and carbopol. Some plant extracts such as guar gum, cellulose, and corn starch may also serve as thickening agents. Additives may also comprise natural ingredients such as poly-saccharides (which are polymeric carbohydrate structures) heparin, dextran, and chitosan, that act as carriers for other ingredients, including persistent antimicrobials. An exemplary sanitizing composition for use in wipes may contain 0.55 vol.-% to 1 vol.-% beeswax. The pH of the sanitizing composition may be adjusted using alkali agents such as sodium hydroxide to control the level of thickening (that is, the desired viscosity) of the sanitizing agent. A pH between 5 and 9 may be desirable.

An exemplary method for preparing a batch of the exemplary sanitizing compositions disclosed above comprises, melting beeswax while mixing with EPL, adding the beeswax/EPL melt to an aliquot of the ethanol (a fraction of the total ethanol required for the batch) while stirring/mixing to form a first mixture, adding the first mixture to the remaining amount of ethanol required for a batch while mixing to form a second mixture, adding the required amounts of the remaining constituents such as isopropyl alcohol, apricot seed oil, Vitamin E extract, and essential oils (fragrance) to the second mixture while mixing to form a third mixture, and adding the required amount of water to the third mixture while mixing. “Batch” means a “pre-determined amount of sanitizing composition” and does not indicate that the sanitizing compositions are required to be prepared using a batch process; semi-continuous or continuous process flow schemes may also be used.

The aliquot of ethanol used for preparing the first mixture may be less than about 2 wt.-% of the ethanol amount required to prepare a pre-determined amount of the sanitizing composition. Preferably the aliquot required to prepare a pre-determined amount of the sanitizing composition of ethanol used for preparing the first mixture is less than about 1 wt.-% of the total ethanol amount.

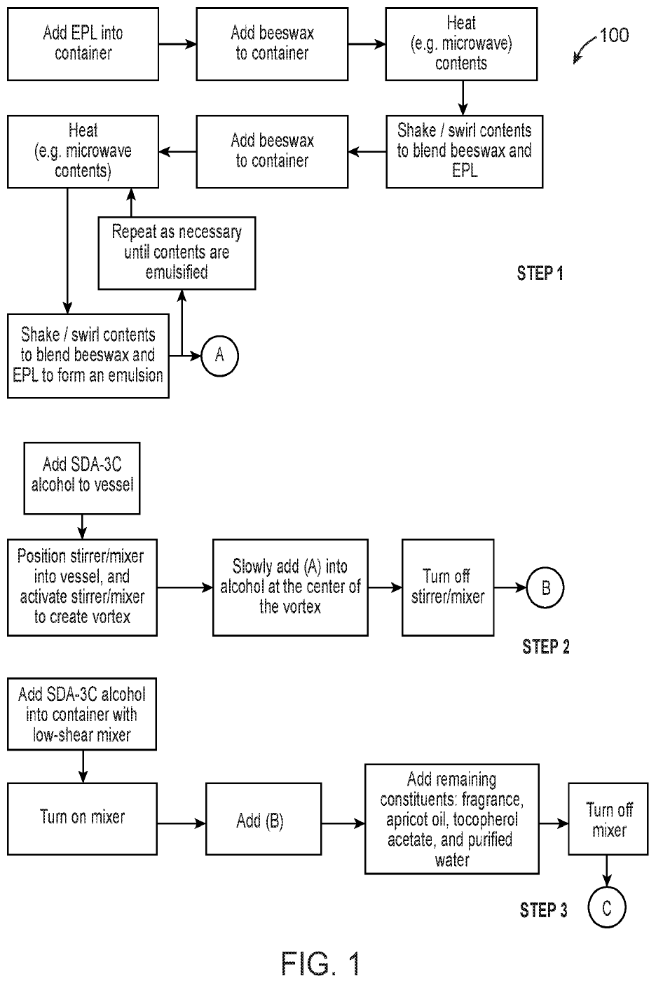

An exemplary method 100 for preparing the exemplary sanitizing compositions disclosed is provided in FIG. 1. In exemplary step 1, an emulsion comprising beeswax and EPL may be formed by mixing beeswax and EPL and heating until an emulsion (A) is formed. The resultant composition may be shaken well to check if an emulsion is formed. The mixing and heating steps may be repeated until an emulsion is formed. For example, emulsification of the EPL and bees wax mixture may be done inside a suitable syringe. Heating may be done for <10 seconds using a microwave oven. An emulsion is a fine dispersion of small droplets of one liquid in another in which it is not soluble or miscible. In exemplary step 2, a first predetermined amount of ethanol may be taken in a vessel and while stirring the ethanol to create a vortex, the emulsion of beeswax and EPL may be slowly added at the center of the vortex (along the axis) to produce an alcohol-beeswax-EPL mixture (B). A vortex is a region in a fluid in which the flow revolves around an axis, which may be straight or curved. In exemplary step 3, mixture B may be added to a second predetermined amount of ethanol in a low shear mixer while mixing. Predetermined amounts of the remaining constituents comprising at least one of essential oils (fragrance), apricot seed oil, tocopherol acetate (Vitamin E), isopropyl alcohol, and water may be added to form the sanitizing composition (C). The steps (other than heating step) are performed at about room temperature, for example, at between 18° C. and 25° C. The first predetermined amount of ethanol may be between about 0.5 vol.-% and about 2 vol.-% of the sum of the first and second predetermined amounts of ethanol. The alcohol used may be Specially Denatured Alcohol (SDA 3C) grade. As previously described, any bee byproduct may be used in Step 1. Bee byproducts need not be limited to beeswax, but may comprise bee propolis, oil extracted from beeswax, and mixtures thereof. Exemplary method 100 may be modified to reduce the number of steps. For example, steps 2 and 3 may be performed using a single step.

The error bounds associated with the percentages of the constituents in the exemplary sanitizing compounds disclosed above is ±1% of the percentages indicated.

### EXAMPLES

### Example 1

### Effectiveness of Various Hand Sanitizing Composition Against E. coli Bacteria

The effectiveness of various hand sanitizing compositions (anti-microbial properties) against E. coli bacterial colonies was measured by plating sanitizing compositions with bacteria and measuring bacterial counts as a function of time at room temperature.

An exemplary sanitizing composition 1 (EX1) comprised (percentages in vol.-%): 60% to 70% ethanol, 3% to 5% vol.-% isopropyl alcohol, 0.1% to 0.4% beeswax, less than 0.1% epsilon polylysine (EPL), less than 1% apricot seed oil, less than 0.3% tocopherol (Vitamin E), and less than 0.2% essential oil extracts of lemon and peppermint. The balance is water.

Another exemplary composition (EX2) was substantially similar to EX1, but was EPL free.

Another exemplary sanitizing composition (EX3) was substantially similar to EX1, but also comprised of about 0.35 wt.-% PHMB.

An over-the-counter (OTC, e.g. Kroger gel) sanitizing composition generally comprises 70 vol.-% ethyl alcohol, isopropyl alcohol, caprylyl glycol, glycerin, isopropyl myristate, tocopheryl acetate, acrylates/C10-30 alkyl acrylate crosspolymer, aminomethyl propanol, fragrance. The balance is water.

Dr. Bronner (DBR) organic hand sanitizer composition generally comprises organic ethyl alcohol, water, organic lavender oil, and organic glycerin.

CleanWell (CWE) alcohol-free and benzalkonium chloride-free all-natural sanitizing composition generally comprises thyme oil (active ingredient), aloe vera (emollient and skin conditioner), citric acid (antioxidant), copper PCA (skin conditioner), sodium decylglucosides hydroxypropyl sulfonate and sodium coco-sulfate(emulsifiers), hydrolyzed oats (skin conditioner), sodium citrate (pH balancer), oregano oil (fragrance)

The bacterial counts were converted to log-scale as follows: 1-log (90% reduction), 2-log (99% reduction), 3-log (99.9% reduction), 4-log (99.99% reduction), 5-log (99.999% reduction) and 6-log (99.999% reduction). Table 1 shows the log reduction of E. coli using the hand sanitizer compositions described above.

TABLE 1
Log-reduction of E. coli using various
hand sanitizing compositions.

| Sanitizer | Time | | |
|---|---|---|---|
| composition | 1 minute | 8 hours | 24 hours |
| EX1 | 5.6 | 3.41 | 5.05 |
| EX2 | 5.6 | 0.24 | 1.98 |
| EX3 | 5.6 | 5.18 | 5.18 |
| OTC | 5.1 | 2.23 | 2.59 |
| DBR | 5.6 | 0.71 | 1.53 |
| CWE | 3.6 | 3.41 | 2.51 |

As can be seen, the exemplary compositions described above exhibited fast acting anti-microbial activity (1 minute) that was at par with OTC and DBR compositions and was significantly better than the alcohol-free composition CWE. The OTC composition contained significantly higher alcohol composition than EX1 and EX2. Regarding persistent antimicrobial activity, EX1 was most effective in reducing bacterial counts, and exhibited about 2-log reduction higher than the other compositions at 24 h. Composition EX3 was the most effective composition and exhibited excellent fast acting and persistent anti-microbial activity.

### Example 2

### Representative Amounts of Constituents to Make an Exemplary Sanitizing Composition Pursuant Method 100

Table 2 shows representative amounts that may be used to prepare an exemplary sanitizing composition pursuant to method 100.

TABLE 2
Representative amount for a sanitizing composition.

| Steps | constituent | Amount or volume |
|---|---|---|
| Step 1 | EPL | about 6.2 ml |
| | beeswax | about 6.6 ml |
| Step 2 | SDA-3C alcohol | about 70 ml |
| Step 3 | SDA-3c alcohol | about 10 liters |
| | fragrance | about 20 ml |
| | apricot oil | about 92 ml |
| | isopropyl alcohol | about 490.2 ml |
| | tocopherol acetate | about 7 ml |
| | purifed water | about 4.6 liters |

The resulting sanitizing composition (EX4) may comprise about (vol.-%): 65.7% ethanol, 3.2% isopropyl alcohol, 0.044% beeswax, 0.045% tocopherol acetate, 0.61% apricot oil, 0.04% EPL, 0.13% fragrance, the remainder being water. Representative properties of the sanitizing composition are shown in Table 3.

TABLE 3
Representative Properties of Exemplary
Sanitizing Composition EX4)

| Physical Properties | EX4 | Dr. Bronners | Purell |
|---|---|---|---|
| Density (g/ml) | 0.88 | 0.88 | 0.88 |
| pH | 6.5-9 | 6.5-8.5 | 6.5-8.5 |
| kinematic Viscosity | 6.60 | 5.80 | 1,000-17,000 |
| (mm²/s) (23 C.) | | | |
| Appearance | translucent thin | thin liquid | gel with |
| | liquid with | | suspended |
| | suspended particles | | bubbles |
| Color | whitish | clear | clear |

Exemplary composition EX4 is a sprayable formulation with a kinematic viscosity of less than 10 cSt (mm²/s). Purell being in gel form has a viscosity>1000 cSt. Dr. Bronners is a sprayable liquid but does not incorporate beeswax. The error bounds associated with the percentages of the constituents in the exemplary sanitizing compounds disclosed above is ±1% of the percentages indicated.

The Abstract is provided to comply with 37 C.F.R. § 1.72(b), to allow the reader to determine quickly from a cursory inspection the nature and gist of the technical disclosure. It should not be used to interpret or limit the scope or meaning of the claims.

Although the present disclosure has been described in connection with the preferred form of practicing it, those of ordinary skill in the art will understand that many modifications can be made thereto without departing from the spirit of the present disclosure. Accordingly, it is not intended that the scope of the disclosure in any way be limited by the above description.

It should also be understood that a variety of changes may be made without departing from the essence of the disclosure. Such changes are also implicitly included in the description. They still fall within the scope of this disclosure. It should be understood that this disclosure is intended to yield a patent covering numerous aspects of the disclosure both independently and as an overall system and in both method and apparatus modes.

Further, each of the various elements of the disclosure and claims may also be achieved in a variety of manners. This disclosure should be understood to encompass each such variation, be it a variation of an implementation of any apparatus implementation, a method or process implementation, or even merely a variation of any element of these.

Particularly, it should be understood that the words for each element may be expressed by equivalent apparatus terms or method terms even if only the function or result is the same. Such equivalent, broader, or even more generic terms should be considered to be encompassed in the description of each element or action. Such terms can be substituted where desired to make explicit the implicitly broad coverage to which this disclosure is entitled. It should be understood that all actions may be expressed as a means for taking that action or as an element which causes that action. Similarly, each physical element disclosed should be understood to encompass a disclosure of the action which that physical element facilitates.

In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising,” are intended to imply the inclusion of a stated element or step or group of elements or steps, but not the exclusion of any other element or step or group of elements or steps. Such terms should be interpreted in their most expansive forms so as to afford the applicant the broadest coverage legally permissible.

### REFERENCES

1. L. Boukraâ, F. Abdellah and L. Ait-Abderrahim, “Antimicrobial Properties of Bee Products and Medicinal Plants,” Microbial Pathogens and Strategies for Combating Them: Science, Technology and Education (A. Méndez-Vilas, Ed.), FORMATEX 2013.
2. M. Kacániová, N. Vukovic, R. Chlebo, P. Ha ŠČik, K. Rovná, J. Cubon, M. Dżugan, A. Pasternakiewicz, “The Antimicrobial Activity of Honey, Bee Pollen Loads And Beeswax from Slovakia,” Arch. Biol. Sci., Belgrade, 64 (3), 927-934, 2012.

1.-27. (canceled)

28. A sanitizing composition comprising a hydrophobic material, wherein the hydrophobic material is a persistent antimicrobial agent, and a solvent.

29. The sanitizing composition of claim 28, wherein the persistent antimicrobial agent comprises a bee byproduct.

30. The sanitizing composition of claim 29, wherein the bee byproduct comprises beeswax.

31. The sanitizing composition of claim 29, wherein the bee byproduct comprises bee propolis.

32. The sanitizing composition of claim 29, wherein the bee byproduct comprises an oil extracted from beeswax.

33. The sanitizing composition of claim 28, wherein the hydrophobic material comprises at least one wax.

34. The sanitizing composition of claim 28, wherein the hydrophobic material comprises epsilon polylysine.

35. The sanitizing composition of claim 28, wherein the hydrophobic material comprises polyethylene glycol.

36. The sanitizing composition of claim 28, wherein the solvent comprises at least one alcohol.

37. The sanitizing composition of claim 28, wherein the solvent is a fast acting antimicrobial agent.

38. The sanitizing composition of claim 28, wherein the solvent comprises water.

39. The sanitizing composition of claim 28, wherein the sanitizing composition comprises an alcohol denaturant.

40. The sanitizing composition of claim 28, wherein the sanitizing composition comprises at least one emollient.

41. The sanitizing composition of claim 28, wherein the sanitizing composition comprises at least one emulsifier.

42. The sanitizing composition of claim 28, wherein the sanitizing composition comprises tea tree extract.

43. The sanitizing composition of claim 28, wherein the sanitizing composition comprises at least one thickening agent.

44. The sanitizing composition of claim 28, wherein the sanitizing composition comprises chlorhexidine.

45. The sanitizing composition of claim 28, wherein the sanitizing composition comprises a gritty material.

46. A method for preparing a sanitizing composition comprising:
forming an emulsion of a hydrophobic material, wherein the hydrophobic material comprises at least one bee byproduct;
adding the emulsion to a first aliquot of at least one alcohol while stirring to form a first mixture;
adding the first mixture to a second aliquot of at least one alcohol while stirring to form a second mixture; and
adding water to the second mixture.

47. The method of claim 46, wherein at least one emollient is added to the second mixture.
